(19) United States
(12) Patent Application Publication
(10) Pub. No.: US 2007/0070811 A1
(43) Pub. Date: Mar. 29, 2007

(54) Multiple tracks scanning tool

(75) Inventor: Homero Castillo, Kingwood, TX (US)

Correspondence Address: GILBRETH ROEBUCK BYNUM DERRINGTON SCHMIDT WALKER;& TRAN, LLP, FROST BANK BUILDING, 6750 WEST LOOP SOUTH, SUITE 920, BELLAIRE, TX, 77401, US

(73) Assignee: Baker Hughes, Inc.

(21) Appl. No.: 11/210,201

(22) Filed: Aug. 23, 2005

(51) Int. Cl. G01V 1/00

(52) U.S. Cl. 367/69

(57) ABSTRACT

A circumferential borehole logging system having a rotating head, wherein the rotating head is provided with more than one transducer. The transducers can be disposed at equidistant apart, or at some other angular value. The number of transducers can range from two up. The logging speed of the system is increased due to the additional transducer coverage. Multiple image data sets can be acquired in a single logging pass when different transducer types are used.

### BACKGROUND OF THE INVENTION

1. Field of the Invention

The invention relates generally to the field of hydrocarbons producing wellbore imaging. More specifically, the present invention relates to circumferential borehole scanning device having more than one transducer.

2. Description of Related Art

Many different types of imaging systems are used in collecting geological data from subterranean formations. The imaging systems include a sonde 10 disposed on a wireline 6 (or other multiconducting cable) that is lowered from the surface 7 into a borehole 2 where the imaging system is activated for collecting the data. The geological data at issue is contained within the formation 8 that surrounds the wellbore 2. The collected geological data is useful for predicting potential hydrocarbon producing zones within the evaluated formation 8. Examples of such imaging systems include radioactive, electrical, nuclear magnetic resonance, and acoustic devices.

With respect to acoustic devices, one subset of these devices is provided with a vibrating transducer that emits a sound wave into the formation. The corresponding waves that reflect from the formation can be recorded and analyzed for formation evaluation. One such prior art acoustic device is shown in FIG. 1 and is referred to herein as a circumferential logging device 14. The circumferential logging device 14 comprises a vibrating acoustic transducer mounted on a rotating head 16 housed in the sonde 10. The transducer is mounted in the sonde 10 behind an acoustic window, in a pressure-compensated, oil-filled cell. Optionally another downhole tool 12 can be included with the circumferential logging device 14. Other compartments in the logging sonde include electronics for actuating the transducer, for controlling the rotary head 16 and for interfacing the electronics with control and display apparatus on the surface through the wireline 6.

In operation, the rotating head 16 rotates thereby allowing the transducer to circumferentially scan the borehole sidewall as the sonde is passed through the borehole. The transducer can be pulsed at a rate of 125 to 250 pulses per scan to provide an equal number of data samples per scan. The pulse frequency varies from 250 kHz to 2 MHz. Preferably the lower frequency is used to get better penetration through the borehole fluid which is highly attenuating at higher pulse frequencies. The driving energy may be coupled to the transducer through a rotary transformer. The vertical resolution between scans depends on the rate at which the sonde 10 is passed through the borehole.

The transducer typically operates in a pulse-echo mode, meaning that it sends and then detects the reflected acoustic pulse from the borehole wall every time it is fired. Thus the acoustic wave reflected from the formation 8, can then be recorded by the same transducer that emitted the wave.

The quantities of interest are the time of flight and the relative amplitudes of the respective reflected echo pulses. The flight time, multiplied by the fluid velocity is a measure of the distance between the transducer and the sidewall, that is, the tool can serve as an acoustic caliper. The echo-signal amplitude may be interpreted as a function of the texture as well as the composition of the sidewall material as estimated from the characteristic acoustic impedance thereof. The respective data samples from a plurality of scans may be processed and displayed as an image as a function of depth when cut along the north line and laid out flat.

Current operation of the circumferential logging device 14 requires that it be passed through the borehole 2 at a certain defined velocity such as 10 ft/min. At this logging speed the intertial effects of borehole friction can allow for intermittent sticking of the sonde 10 within certain portions of the borehole 2. Since the wireline 6 is elastic, continued upward pulling stretches the wireline 6 and increases its tension until the sonde 10 becomes unstuck. When the sonde 10 becomes unstuck it can suddenly advance up the borehole at an increased rate thereby producing a “lurching” effect. Sudden velocity changes of the circumferential logging device 14 can provide erroneous geological data readings. Therefore, there exists a need for a device and method of collecting circumferential logging data that eliminates any lurching effects.

### BRIEF SUMMARY OF THE INVENTION

The present invention includes a circumferential borehole logging device comprising, an elongated sonde having a rotating head, and a first transducer and a second transducer disposed on the rotating head. The first transducer and said second transducer can be spaced apart at substantially 180° from one another. Optionally, the first transducer and the second transducer can be spaced apart at less than 180° from one another. The first and said second transducer can be electrically powered, radioactive, a nuclear magnetic resonant device, radar, a laser, an electro-magnetic device, acoustic devices, and combinations thereof.

The first transducer and the second transducer can lie substantially within the same plane that lies perpendicular to the axis of said rotating head, or can be disposed in different planes. A third transducer can also be disposed on said rotating head. Moreover, when the logging device comprises at least three transducers, these transducers can be radially disposed substantially equidistant apart or can be radially disposed at differing radial distances from one another. Moreover, the transducers can be substantially located within a plane that perpendicularly intersects the axis of the rotating head. Optionally, the transducers can be located within more than one plane, wherein each plane perpendicularly intersects the axis of the rotating head at a different point along the axis. The circumferential logging device can be disposable within a borehole.

Also included with the present disclosure is a logging system comprising, a data collection device, a sonde disposable within a wellbore, a circumferential borehole logging device included with the sonde, wherein the circumferential borehole logging device includes a rotating head, a first transducer disposed on the rotating head, and a second transducer disposed on the rotating head. Optionally, the first transducer and the second transducer are spaced apart at substantially 180° from one another. The first transducer and said second transducer are spaced apart at less than 180° from one another. The transducers can be electrical devices, radioactive devices, nuclear magnetic resonant, radar, laser, electro-magnetic, acoustic devices, and combinations thereof.

The first transducer and the second transducer of the logging system can be substantially within the same plane that lies perpendicular to the axis of the rotating head. Optionally, the first transducer and the second transducer can be within different planes that lie perpendicular to the axis of the rotating head at different locations on the axis. Alternatively the logging system can further comprise at least one additional transducer disposed on the rotating head, yet further optionally these transducers can be radially disposed substantially equidistant apart. The transducers can be of electrical, radioactive, nuclear magnetic resonant, radar, laser, electro-magnetic, acoustic devices, and combinations thereof.

### BRIEF DESCRIPTION OF THE SEVERAL VIEWS OF THE DRAWING

FIG. 1 depicts a partial cross sectional view of a downhole tool disposed in a wellbore.

FIG. 2a illustrates an overhead view of a rotating head of a circumferential logging device.

FIG. 2b shows a side view of a rotating head of a circumferential logging device.

FIG. 3a illustrates an overhead view of one embodiment of a rotating head of a circumferential logging device.

FIG. 3b portrays a side view of an embodiment of a rotating head of a circumferential logging device.

FIG. 4a illustrates an overhead view of one embodiment of a rotating head of a circumferential logging device.

FIG. 4b portrays a side view of an embodiment of a rotating head of a circumferential logging device.

FIG. 5 depicts scan lines of a circumferential logging device having a single transducer.

FIG. 6 illustrates scan lines of an embodiment of a circumferential logging device having two transducers spaced roughly 180° apart.

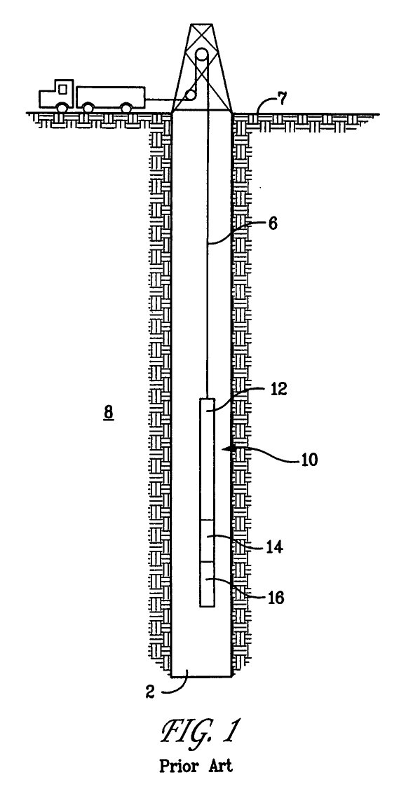

### DETAILED DESCRIPTION OF THE INVENTION

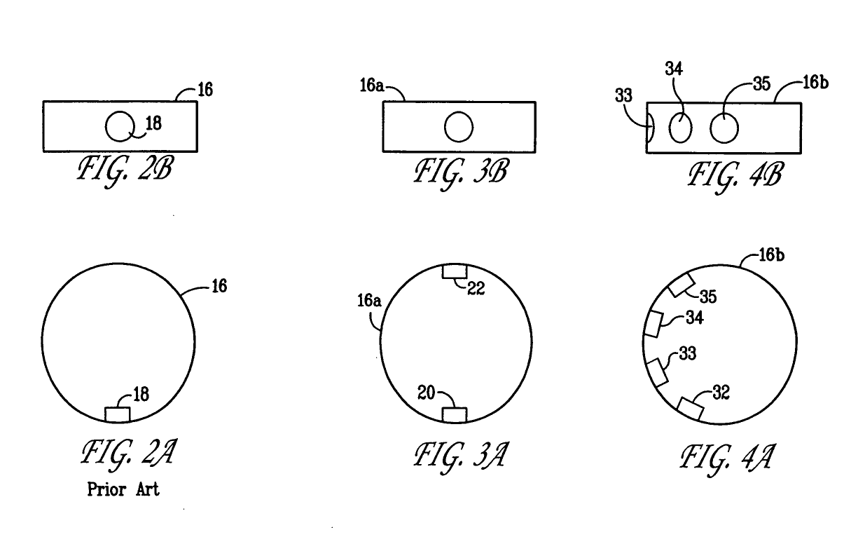

The present disclosure concerns a circumferential logging device having at least two transducers capable of emitting a signal from the device. FIGS. 2a and 2b depict respectively in overhead and side view, a rotating head 16 with an associated transducer 18. In contrast, shown respectively in overhead and side view of FIGS. 3a and 3b, the embodiment of the circumferential logging device disclosed herein includes at least two transducers (20, 22) on the rotating head 16a.

These transducers (20, 22) as shown are disposed substantially 180° apart and on roughly the same radial plane of the rotating head 16a. However the angular distance separating these two can be less than 180° depending either on the application or the particular desing. Moreover, these transducers (20, 22) can also be disposed at different vertical distances along the axis of the rotating head 16a and need not be restricted to lying within the same radial plane. The transducers (20, 22) can be of the same or a different type, for example one acoustic and the other electrical, or both acoustic. Within the same type, these transducers can operate with different principles, for example acoustic transducer could be comprised of piezo-electric, electro magnetic acoustic transducers, or any other type of device capable of producing and detecting acoustic vibrations.

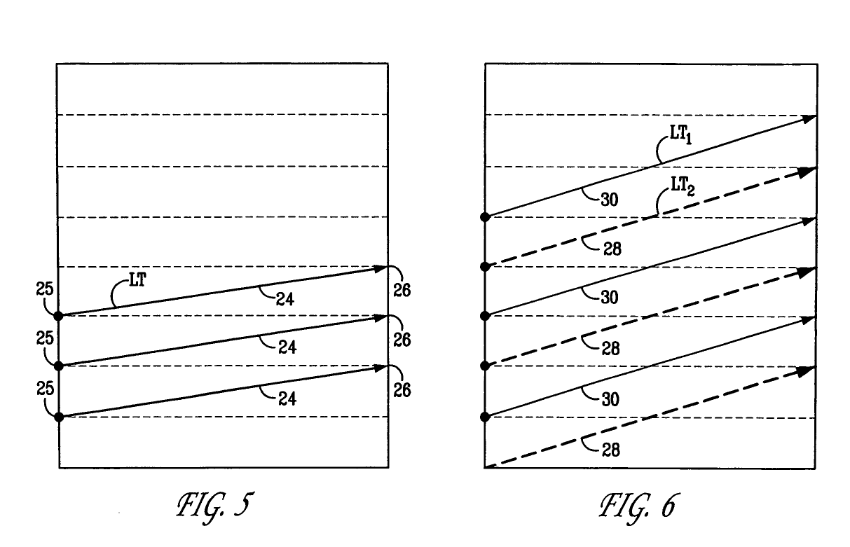

With reference now to FIGS. 5 and 6, FIG. 5 illustrates a scan line L_{T} that represents the path scanned by the transducer 18 in the prior art device. As shown, the scan line L_{T} is a two dimensional representation of a circumferential logging sweep performed within a borehole 2. Each 360° sweep is represented by an individual ray 24 having a starting point 25 and an end point 26. Thus to represent the three-dimensional scan line path, it is cut along a line axial to the borehole 2 and shown in the two-dimensional depiction of FIG. 4. In this figure the ordinate represents travel along the wellbore, and the abscissa represents angular displacement along the inner radius of the borehole 2. The scan line L_{T} is a single helical path comprised of the individual rays 24 where the end point 26 of each ray 24 coincides in space with the starting point 25 of the next above adjacent ray 24. Thus each of the starting points (25) and each of the end points (26) lie along a single line that axially runs along the borehole 2 and on its inner radius. Since each ray 24 represents a 360° sweep, the scan line L_{T} was created as a result of three rotations of the associated circumferential logging device 14.

FIG. 6 contains scan lines (L_{T1} and L_{T2}) representative of the respective scan paths of the two transducers (20, 22) disposed on the rotating head 16a. The solid scan line L_{T1} represents the scan path of one of the transducers (20 or 22) and the dashed scan line L_{T2} represents the path of the other transducer (20 or 22). Each 360° sweep of the transducers (20, 22) is represented by a single ray (28, 30), and like the scan line L_{T} of FIG. 4, the scan lines (L_{T1}, L_{T2}) of FIG. 6 represent three rotations of the associated circumferential logging device 14. As can be seen in FIG. 5, three rotations of the circumferential logging device 14 as disclosed herein results in six rays (28 and 30), which is twice the number produced by the prior art device. Moreover, the time required to complete three rotations with the present device (FIG. 5) is no more than that required for the prior art device (FIG. 4). While the rotational velocity of the present device can remain roughly same as that of presently used devices, the speed of which it passes through the borehole 2 can be substantially increased thereby eliminating the lurching effect. Accordingly, one of the advantages of the present device is its ability to reduce the time required for imaging a borehole 2. An additional advantage is to improve the data resolution and accuracy, and yet maintain the same density of measurement acquired with a single transducer.

It should be pointed out that the scope of the present invention is not limited to circumferential logging devices having up to two transducers on their respective rotating heads. Instead the device as disclosed herein can include more than two transducers on the associated rotating head 16a. Moreover, the transducers need not be equidistantly spaced around the rotating head, i.e. 180° apart for two and 120° apart for three and so on, but can be separated by some other angular value. For example, with reference now to FIGS. 4a and 4b, transducers (32, 33, 34, 35) are shown radially disposed within a 180° segment of the rotating head 16b.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. For example, circumferential borehole logging tool 14 can be coupled with other downhole tools, such as those used for imaging, perforations, and completions, to name but a few. These and other similar modifications will readily suggest themselves to those skilled in the art, and are intended to be encompassed within the spirit of the present invention disclosed herein and the scope of the appended claims.

1. A borehole logging device comprising:
a rotating head;
a first transducer disposed on said rotating head; and
a second transducer disposed on said rotating head wherein said first and said second transducers are substantially within a plane perpendicular to the axis of the rotating head.

2. The logging device of claim 1 wherein said first transducer and said second transducer are spaced apart at substantially 180° from one another.

3. The logging device of claim 1 wherein said first transducer and said second transducer are spaced apart at less than 180° from one another.

4. The logging device of claim 1, wherein said first and said second transducer are selected from the list consisting of electrical, radioactive, nuclear magnetic resonant, radar, laser, electro-magnetic, acoustic devices, and combinations thereof.

5. (canceled)

6. (canceled)

7. The logging device of claim 1 further comprising at least a third transducer disposed on said rotating head.

8. The logging device of claim 7 wherein said transducers are radially disposed substantially equidistant apart.

9. The logging device of claim 7 wherein said transducers are radially disposed at differing radial distances from one another.

10. The logging device of claim 7 wherein said transducers are substantially located within a plane that perpendicularly intersects the axis of the rotating head.

11. (canceled)

12. The logging device of claim 1, wherein said device is disposable within a borehole.

13. (canceled)

14. The logging method of claim 23 wherein said first transducer and said second transducer are spaced apart at substantially 180° from one another.

15. The logging method of claim 23 wherein said first transducer and said second transducer are spaced apart at less than 180° from one another.

16. The logging method of claim 23, wherein said transducers are selected from the list consisting of electrical, radioactive, nuclear magnetic resonant, radar, laser, electro-magnetic, acoustic devices, and combinations thereof.

17. (canceled)

18. (canceled)

19. The logging method of claim 23 further comprising adding at least one additional transducer to said rotating head.

20. The logging method of claim 19 wherein said transducers are radially disposed substantially equidistant apart.

21. The logging method of claim 19, wherein said transducers are selected from the list consisting of electrical, radioactive, nuclear magnetic resonant, radar, laser, electro-magnetic, acoustic devices, and combinations thereof.

22. The logging device of claim 1 further comprising a sonde.

23. A logging method comprising:
disposing a rotating head within a wellbore having a first and a second transducer, wherein the first and second transducers are disposed substantially within a plane that is perpendicular to the axis of the rotating head;
rotating the transducers within the wellbore; and
scanning the wellbore with said transducers.
